(19) United States
(12) Patent Application Publication
(10) Pub. No.: US 2025/0080833 A1
(43) Pub. Date: Mar. 6, 2025

(54) CONTROL SYSTEM, IMAGE CAPTURING APPARATUS AND CONTROL METHOD THEREOF, AND STORAGE MEDIUM

(71) Applicant: CANON KABUSHIKI KAISHA, Tokyo (JP)

(72) Inventor: Youjirou Hiratsuka, Kanagawa (JP)

(21) Appl. No.: 18/817,343

(22) Filed: Aug. 28, 2024

(30) Foreign Application Priority Data
Sep. 6, 2023 (JP) 2023-144704

(51) Int. Cl. H04N 23/63; H04N 23/61; H04N 23/62; H04N 23/667

(52) U.S. Cl. CPC H04N 23/635; H04N 23/61; H04N 23/62; H04N 23/667

(57) ABSTRACT

A control system in which a plurality of image capturing apparatuses are controlled by a control apparatus, wherein the control apparatus includes, a display control unit configured to be capable of controlling display device to display a live view image sent from each of the plurality of image capturing apparatuses in a plurality of display regions and capable of changing a display method for each of the plurality of display regions, and a first communication unit configured to request the live view image from each of the image capturing apparatuses, and each of the image capturing apparatuses includes an image capturing device configured to generate the live view image at a different image quality, and a second communication unit configured to send the live view image generated by the image capturing device to the control apparatus.

### BACKGROUND OF THE INVENTION

### Field of the Invention

The present invention relates to a control system that controls a plurality of cameras to shoot images.

### Description of the Related Art

In recent years, photographers at sporting events such as the Olympics shoot a wide range of scenes from various competitions, and the photographs taken are often distributed throughout the news media.

In such competitions, systems are used in which a plurality of digital cameras are installed facing in a variety of angles, and those cameras can be remotely controlled using portable control apparatuses. In such a system, a small number of photographers can control a plurality of digital cameras at once by operating the control apparatuses, which are, for example, tablets or laptop computers connected to the cameras over a network.

Existing technologies such as Nikon Corporation's “NX Field” and Sony Corporation's “Remote Camera Tool” are sometimes used as software capable of remotely controlling photography by a plurality of digital cameras. Document 1 (Nikon “NX Field System User Manual”. Retrieved Aug. 15, 2023, from https://nps.nikonimaging.com/technical_info/nx_field/pdf/NXFieldUM_Jp_ver.1.3.pdf) and Document 2 (“How to Use the Remote Camera Tool”. Retrieved Aug. 15, 2023, from https://support.d-imaging.sony.co.jp/app/remotecameratool/ja/instruction/1_connection.php) disclose methods for using this software.

Multiple media organizations such as news agencies join the networks at competition venues, and it is therefore necessary to provide a communication environment for each media organization. Accordingly, the networks provided to each media organization may be limited. Furthermore, digital cameras and control apparatuses connected by the plurality of media organizations are constantly communicating by sending live view images, release instructions to shoot images, image transfer instructions, and the like. The resulting large amount of data communication strains the communication bandwidth, increases the processing load of the control apparatuses, and the like.

As such, in an environment in which such a remote shooting system is used, it is desirable to avoid unnecessary communication to the greatest extent possible when transferring live view images, captured images, and the like.

Japanese Patent Laid-Open No. 2014-176016 discloses a technique in which an image of an appropriate image quality is sent from a shooting camera to a control apparatus in accordance with the processing performance of the control apparatus.

In athletic competitions such as the Olympics, multiple types of competitions are held in a single stadium, and it is necessary to shoot images having a variety of compositions for each of the competitions. For example, in a situation where track and field competitions are being held simultaneously in a stadium, images are shot remotely while displaying live view images from a plurality of digital cameras in a control apparatus side by side. Here, displaying all the live view images at a high resolution and a high framerate takes up extensive communication bandwidth and increases the processing load on the control apparatus. On the other hand, displaying all the live view images at a low resolution and a low framerate reduces the usability, e.g., by causing delays in responding to changing circumstances, resulting in the risk that critical moments for shooting images will be missed.

There is thus a tradeoff between image quality and usability of the live view image, and it is therefore necessary to select the optimal image quality and display the images at that quality in accordance with the shooting situation, the operation status of the control apparatus, and the like.

However, with existing technologies such as the aforementioned NX Field and Remote Camera Tool, the resolution, framerate, and the like of the live view image sent from the digital camera can be set in advance, but the image quality settings of the live view image cannot be changed in response to changes in the circumstances.

Meanwhile, with the technique disclosed in Japanese Patent Laid-Open No. 2014-176016, the image quality settings of a plurality of images can be changed collectively in accordance with the processing performance of the control apparatus, but the image quality of the live view image cannot be changed for each individual image.

### SUMMARY OF THE INVENTION

Having been achieved in light of the foregoing issues, the present invention provides a control system that, when controlling a plurality of image capturing apparatuses using a control apparatus, is capable of suppressing a drop in usability while also reducing communication volume.

According to a first aspect of the present invention, there is provided a control system in which a plurality of image capturing apparatuses are controlled by a control apparatus, wherein the control apparatus includes: at least one processor or circuit configured to function as: a display control unit configured to be capable of controlling display device to display a live view image sent from each of the plurality of image capturing apparatuses in a plurality of display regions, each corresponding to one of the plurality of image capturing apparatuses, in the display device, and capable of changing a display method for each of the plurality of display regions; and a first communication unit configured to request the live view image from each of the image capturing apparatuses, and each of the image capturing apparatuses includes: an image capturing device configured to generate the live view image at a different image quality according to a send request for the live view image from the control apparatus; and at least one processor or circuit configured to function as a second communication unit configured to send the live view image generated by the image capturing device to the control apparatus.

According to a second aspect of the present invention, there is provided an image capturing apparatus controlled by a control apparatus, the image capturing apparatus comprising: an image capturing device configured to generate a live view image at a different image quality according to a send request for the live view image from the control apparatus; and at least one processor or circuit configured to function as a communication unit configured to send the live view image generated by the image capturing device to the control apparatus.

According to a third aspect of the present invention, there is provided a method for controlling an image capturing apparatus controlled by a control apparatus, the method comprising: performing image capturing that generates a live view image at a different image quality according to a send request for the live view image from the control apparatus; and sending the live view image generated in the image capturing to the control apparatus.

Further features of the present invention will become apparent from the following description of exemplary embodiments with reference to the attached drawings.

### BRIEF DESCRIPTION OF THE DRAWINGS

FIGS. 1A to 1C are hardware configuration diagrams illustrating the configuration of a digital camera.

FIG. 2 is a hardware configuration diagram illustrating the configuration of a control apparatus.

FIG. 3 is a diagram illustrating the configuration of a camera control system.

FIGS. 4A and 4B are diagrams illustrating the relationships between a plurality of digital cameras and the control apparatus at a competition venue.

FIG. 5A is a diagram illustrating a state in which live view images from the plurality of digital cameras are displayed in the control apparatus.

FIG. 5B is a diagram illustrating a state in which live view images from the plurality of digital cameras are displayed in the control apparatus.

FIG. 5C is a diagram illustrating an example of the configuration of an individual camera control section.

FIG. 5D is a diagram illustrating an example of the configuration of an individual camera control section.

FIG. 5E is a diagram illustrating an example of the configuration of an individual camera control section.

FIG. 5F is a diagram illustrating a registration settings screen for an individual camera.

FIG. 6A is a flowchart illustrating an example of operations performed by the control apparatus according to a first embodiment.

FIG. 6B-1 and FIG. 6B-2 are flowcharts illustrating an example of operations performed by the control apparatus according to the first embodiment.

FIG. 7 is a flowchart illustrating operations performed by the digital camera according to the first embodiment.

FIG. 8 is a diagram illustrating a state in which live view images from the plurality of digital cameras are displayed side by side in a multi-remote shooting screen.

FIG. 9 is a flowchart illustrating operations performed by the digital camera according to a second embodiment.

FIG. 10 is a diagram illustrating the configuration of the camera control system according to a third embodiment.

FIG. 11A is a diagram illustrating a state in which multi-remote shooting is performed using separate control apparatuses during the same competition.

FIG. 11B is a diagram illustrating a state in which multi-remote shooting is performed using separate control apparatuses during the same competition.

FIG. 12 is a flowchart illustrating operations performed by the digital camera according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Configuration of Digital Camera 100

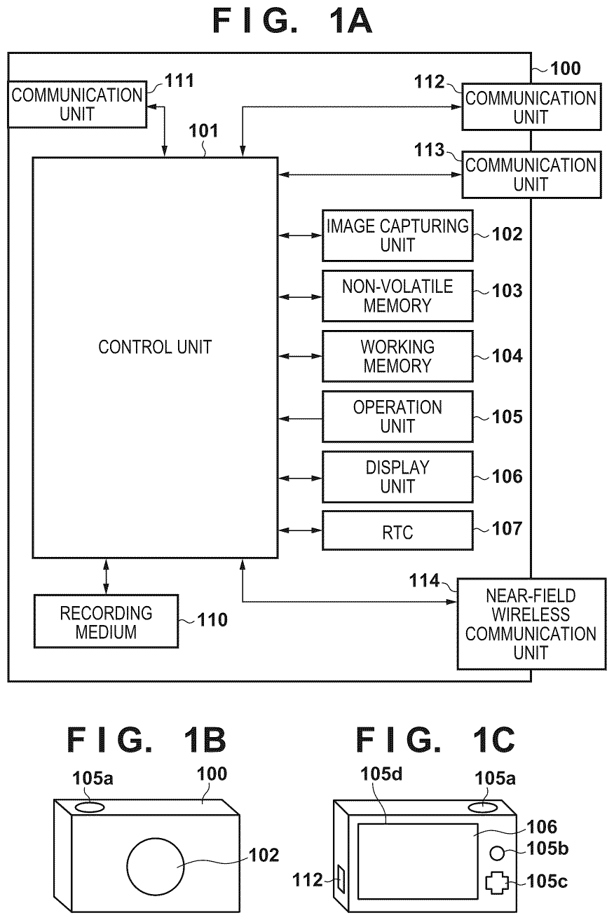

FIG. 1A is a hardware configuration diagram illustrating an example of the configuration of a digital camera (image capturing apparatus) 100 in a camera control system according to a first embodiment of the present invention. A case where a smartphone is used as an example of a control apparatus included in the camera control system will be described here, but the control apparatus is not limited thereto. For example, the control apparatus may be any information processing apparatus, such as a portable media player, what is known as a “tablet device”, a personal computer, or the like.

In the digital camera 100, a control unit 101 controls the various parts of the digital camera 100 in response to input signals, programs (described later), and the like. Note that a plurality of pieces of hardware may control the overall apparatus by sharing processing, rather than the control unit 101 controlling the overall apparatus.

An image capturing unit 102 is constituted by, for example, an optical imaging system that controls an optical lens unit as well as aperture stop, zoom, and focus, an image sensor for converting an optical image formed through the optical lens unit into an electrical image signal, and the like. A complementary metal oxide semiconductor (CMOS) sensor, a charge coupled device (CCD), or the like is typically used as the image sensor.

Under the control of the control unit 101, the image capturing unit 102 uses the image sensor to convert subject light, formed as an image by a lens included in the image capturing unit 102, into an electrical signal, performs noise reduction processing and the like, and outputs digital image data. The digital camera 100 according to the present embodiment records image data files into a recording medium 110 in accordance with the design rule for camera filesystem (DCF) standard.

A non-volatile memory 103 is a non-volatile memory that can be electrically erased and recorded to, and stores programs and the like (described later) that are executed by the control unit 101. A working memory 104 is used as a buffer memory that temporarily stores the image data captured by the image capturing unit 102, an image display memory for a display unit 106, a work region for the control unit 101, and the like.

An operation unit 105 is used for accepting instructions made to the digital camera 100 by a user. The operation unit 105 includes, for example, a power button through which the user instructs the power of the digital camera 100 to be turned on and off, a release switch for instructing a shot to be taken, a playback button for instructing image data to be played back, and the like. The operation unit 105 further includes operation members such as a dedicated “connect” button for starting communication with an external device via a communication unit 111 (described later). The operation unit 105 also includes a touch panel 105d disposed on the display unit 106 (described later).

Note that the release switch includes a switch SW1 and a switch SW2. The switch SW1 turns on when the release switch is put into what is known as a “half-pressed” state. Shooting preparation operations such as autofocus (AF) processing, automatic exposure (AE) processing, auto white balance (AWB) processing, flash pre-emission (EF) processing, and the like are performed as a result. The switch SW2 turns on when the release switch is put into what is known as a “fully-pressed” state. Shooting operations are performed as a result.

The display unit 106 displays a viewfinder image at the time of shooting, shot image data, text for interactive operations, and the like. Note that the display unit 106 does not absolutely need to be built into the digital camera 100. It is sufficient for the digital camera 100 to be capable of connecting to an internal or external display unit 106 and have at least a display control function for controlling the display in the display unit 106.

An RTC 107 manages time. The time is managed based on time settings input by a user through the operation unit 105, time information obtained through the communication unit 111, time information obtained by a radio wave clock, and or the like. Any method can be used to input the time as long as the time can be managed.

The recording medium 110 records image data output from the image capturing unit 102. The recording medium 110 may be configured to be removable from the digital camera 100, or may be built into the digital camera 100. In other words, it is sufficient for the digital camera 100 to at least have means for accessing the recording medium 110.

The communication unit 111 is an interface for connecting to an external device. The digital camera 100 of the present embodiment can exchange data with the external device through the communication unit 111. For example, the image data generated by the image capturing unit 102 can be sent to the external device through the communication unit 111. In the present embodiment, the communication unit 111 includes an interface for communicating with an external device through what is known as “wireless LAN”, based on the IEEE 802.11 standard. The control unit 101 implements wireless communication with the external device by controlling the communication unit 111. Note that the communication method is not limited to wireless LAN, and includes an infrared communication method as well, for example.

A communication unit 112 is an interface for connecting to an external device. The digital camera 100 of the present embodiment can exchange data with the external device through the communication unit 112. For example, the image data generated by the image capturing unit 102 can be sent to the external device through the communication unit 112. In the present embodiment, the communication unit 112 includes an interface for communicating with an external device through what is known as “Bluetooth” (registered trademark), based on the IEEE 802.15.1 standard. The control unit 101 implements wireless communication with the external device by controlling the communication unit 112. Note that the communication method is not limited to Bluetooth, and includes wireless LAN known from the IEEE 802.11 standard or an infrared communication method as well, for example.

A communication unit 113 is an interface for connecting to an external device. The digital camera 100 of the present embodiment can exchange data with the external device through the communication unit 113. For example, the image data generated by the image capturing unit 102 can be sent to the external device through the communication unit 113. In the present embodiment, the communication unit 113 includes an interface for communicating with an external device through wired LAN (Ethernet), based on the IEEE 802.3 standard. The control unit 101 implements communication with the external device by controlling the communication unit 113. Note that the communication method is not limited to wired LAN, and includes a USB communication method as well, for example.

Note that the communication unit 112 of the digital camera 100 according to the present embodiment has a “peripheral mode” and a “central mode” as operating modes. By operating the communication unit 112 in the peripheral mode, the digital camera 100 according to the present embodiment can operate as a client device according to Bluetooth. When the digital camera 100 operates as a client device, communication is possible by connecting to an external device that is set to the central mode. To authenticate the external device which is connected to, unique information of the external device being connected to is stored in the non-volatile memory 103 by performing pairing in advance. Additionally, if power is supplied to the Bluetooth module, the digital camera 100 is capable of transmission even when the power switch is turned off.

A near-field wireless communication unit 114 is constituted by, for example, an antenna for wireless communication, a modulation/demodulation circuit and a communication controller for processing wireless signals, and the like. The near-field wireless communication unit 114 outputs modulated wireless signals from the antenna and demodulates wireless signals received from the antenna to implement non-contact near field communication according to the ISO/IEC 18092 standard (known as “Near-Field Communication” (NFC)). The near-field wireless communication unit 114 according to the present embodiment is disposed on a side part of the digital camera 100.

Communication between the digital camera 100 and a control apparatus 200 (described later) is started, and a connection is established, by bringing the near-field wireless communication unit 114 and a near-field wireless communication unit 214 into proximity with each other. Note that when a connection is established with the control apparatus 200 using the near-field wireless communication unit 114, it is not absolutely necessary to bring the near-field wireless communication unit 114 and the near-field wireless communication unit 214 into contact with each other. The near-field wireless communication unit 114 and the near-field wireless communication unit 214 can communicate even when separated by a certain distance, and thus to connect the devices to each other, it is sufficient to bring the units into a range where near-field wireless communication is possible. The following descriptions will also refer to bringing the units into a range where near-field wireless communication is possible as bringing the units “near” or “into proximity with” each other.

The appearance of the digital camera 100 will be described next. FIGS. 1B and 1C are diagrams illustrating an example of the appearance of the digital camera 100. A release switch 105a, a playback button 105b, a directional key 105c, and the touch panel 105d are operation members included in the operation unit 105 described above. Images obtained through the capturing by the image capturing unit 102 are also displayed in the display unit 106. The digital camera 100 according to the present embodiment also includes an antenna part of a power supply unit 116 on a side surface of the camera housing. Power can be supplied by bringing power supply units 116 to within a certain distance from each other. Non-contact power supply, which does not require a cable or the like, can be performed, and the supply of power can be controlled to start and end, as a result.

Although the following descriptions may refer to the digital camera 100 as being the entity performing the processing, it is actually the control unit 101 of the digital camera 100 that loads programs stored in the non-volatile memory 103 and implements the various types of processing.

The foregoing has described the digital camera 100.

### Configuration of Control Apparatus 200

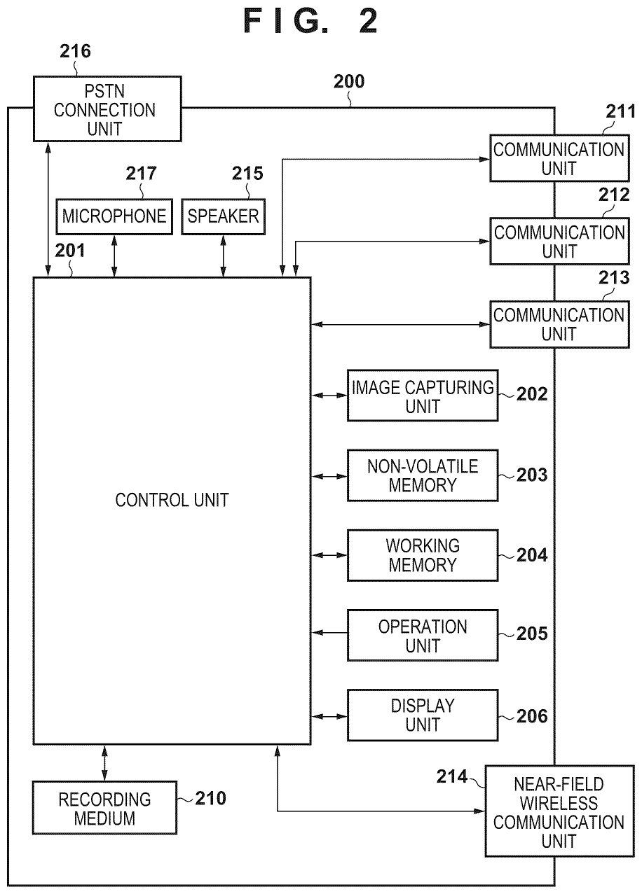

FIG. 2 is a hardware configuration diagram illustrating an example of the configuration of the control apparatus 200 according to the present embodiment. A case where the control apparatus 200 is used as an example of a control apparatus included in the camera control system will be described here, but the control apparatus is not limited thereto. The control apparatus may be a digital camera having wireless functionality, a tablet device, a personal computer, or the like, for example.

In the control apparatus 200, a control unit 201 controls the various parts of the control apparatus 200 in accordance with input signals, programs (described later), and the like. Note that a plurality of pieces of hardware may control the overall apparatus by sharing processing rather than the control unit 201 controlling the overall apparatus.

Anon-volatile memory 203 is a non-volatile memory that can be electrically erased and recorded to. An operating system (OS), which is basic software executed by the control unit 201, applications that implement practical functions by operating cooperatively with the OS, and the like are recorded in the non-volatile memory 203. Additionally, in the present embodiment, an application (“app” hereinafter) for communicating with the digital camera 100, for example, is stored in the non-volatile memory 203.

A working memory 204 is used as an image display memory for a display unit 206, a work region for the control unit 201, and the like.

An operation unit 205 is used for accepting instructions made to in the control apparatus 200 by a user. The operation unit 205 includes operation members such as, for example, a power button through which the user instructs the power of the control apparatus 200 to be turned on and off, an operation member for setting an RTC 207, a touch panel 206d disposed on the display unit 206, and the like.

The display unit 206 displays image data, a text display for interactive operations, and the like. Note that the control apparatus 200 does not absolutely need to include the display unit 206. It is sufficient for the control apparatus 200 to be capable of connecting to the display unit 206 and have at least a display control function for controlling the display in the display unit 206.

The RTC 207 manages a clock. The time is managed based on time settings input by a user through the operation unit 205, time information obtained through a communication unit 212 or a PSTN connection unit 216, time information obtained by a radio wave clock, and or the like. Any method can be used to input the time as long as the time can be managed. The time may also be obtained by a detection mechanism from a mechanical mechanism such as an analog clock. In this case, the RTC 207 is assumed to include the detection mechanism for detection from the analog clock.

A recording medium 210 can record image data transferred from the digital camera 100 to the control unit 201 through a communication unit 211. The recording medium 210 may be configured to be removable from the control apparatus 200, or may be built into the control apparatus 200. In other words, it is sufficient for the control apparatus 200 to at least have means for accessing the recording medium 210.

The communication unit 211 is an interface for connecting to an external device. The control apparatus 200 of the present embodiment can exchange data with the external device through the communication unit 211. In the present embodiment, the communication unit 211 is an antenna, and the control unit 201 can connect to the digital camera 100 via the antenna. In the present embodiment, the communication unit 211 includes an interface for communicating with an external device through what is known as “wireless LAN”, based on the IEEE 802.11 standard. The control unit 201 implements wireless communication with the external device by controlling the communication unit 211. Note that the communication method is not limited to wireless LAN, and includes an infrared communication method as well, for example.

The communication unit 212 is an interface for connecting to an external device. The control apparatus 200 of the present embodiment can exchange data with the external device through the communication unit 212. The control apparatus 200 can receive image data generated by the digital camera 100 through the communication unit 212, for example. In the present embodiment, the communication unit 212 includes an interface for communicating with an external device through what is known as “Bluetooth” (registered trademark), based on the IEEE 802.15.1 standard. The control unit 201 implements wireless communication with the external device by controlling the communication unit 212. Note that the communication method is not limited to Bluetooth, and includes wireless LAN known from the IEEE 802.11 standard or an infrared communication method as well, for example.

A communication unit 213 is an interface for connecting to an external device. The control apparatus 200 of the present embodiment can exchange data with the external device through the communication unit 213. The control apparatus 200 can receive image data generated by the digital camera 100 through the communication unit 213, for example. In the present embodiment, the communication unit 213 includes an interface for communicating with an external device through wired LAN (Ethernet), based on the IEEE 802.3 standard. The control unit 201 implements communication with the external device by controlling the communication unit 213. Note that the communication method is not limited to wired LAN, and includes a USB communication method as well, for example.

Note that the communication unit 212 of the control apparatus 200 according to the present embodiment has a “peripheral mode” and a “central mode” as operating modes. By operating the communication unit 212 in the central mode, the control apparatus 200 according to the present embodiment can operate as a server device according to Bluetooth. When the control apparatus 200 operates as a server device, communication can be performed by connecting to an external device that is set to the peripheral mode. To authenticate the external device which is connected to, unique information of the external device being connected to is stored in the non-volatile memory 203 by performing pairing in advance.

The near-field wireless communication unit 214 is constituted by, for example, an antenna for wireless communication, a modulation/demodulation circuit and a communication controller for processing wireless signals, and the like. The near-field wireless communication unit 214 outputs modulated wireless signals from the antenna and demodulates wireless signals received from the antenna to implement non-contact near field communication according to the ISO/IEC 18092 standard (known as “Near Field Communication” (NFC)). The near-field wireless communication unit 214 according to the present embodiment is disposed on a side part of the control apparatus 200.

Although the following descriptions may refer to the control apparatus 200 as being the entity performing the processing, it is actually the control unit 201 of the control apparatus 200 that loads the programs of apps (or the functions of the apps, an OS, services of the OS, or the like) loaded into the working memory 204, and implements various types of processing.

### System Configuration

The configuration of the camera control system according to the present embodiment will be described next.

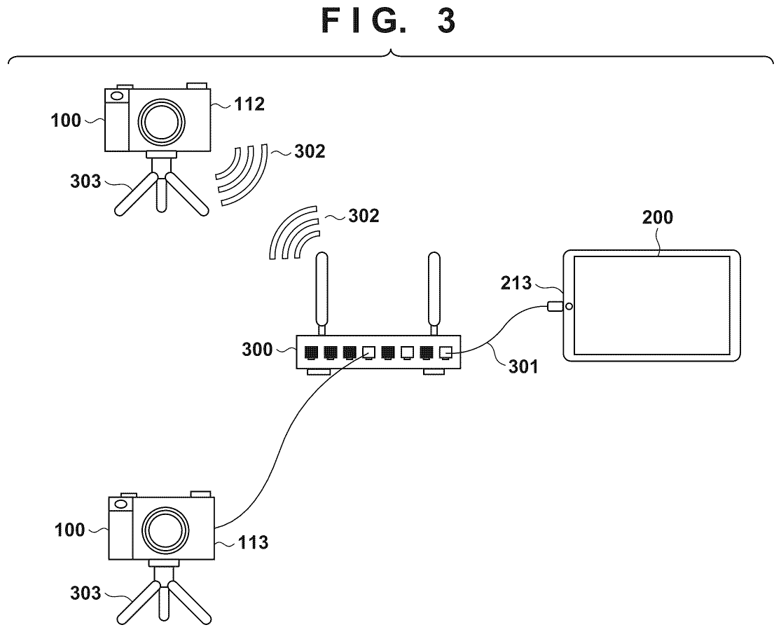

FIG. 3 is a diagram illustrating the configuration of a system in which the control apparatus 200 and a plurality of the digital cameras 100 are connected through a network device 300, and the digital cameras 100 can be controlled remotely by the control apparatus 200.

Each digital camera 100 is mounted on a tripod 303 or the like, and is installed in a corresponding shooting position. Although the present embodiment describes an installation method in which the digital camera 100 is installed on the tripod 303, the digital camera 100 may instead be installed on a remote gimbal through which pan, tilt, and zoom operations can be controlled remotely.

The following can be considered as examples of connection modes for the communication between the digital camera 100 and the control apparatus 200. One mode is the digital camera 100 connecting to the network device 300 through wireless communication over radio waves 302 through the communication unit 112, and communicating with the control apparatus 200. Another mode is the digital camera 100 connecting to the network device 300 over a wired LAN through the communication unit 113, and communicating with the control apparatus 200.

Yet another mode is the control apparatus 200 connecting to the network device 300 through wireless communication over radio waves 302 through the communication unit 212, and communicating with the digital camera 100. Still another mode is the control apparatus 200 connecting to the network device 300 over a wired LAN through the communication unit 213, and communicating with the digital camera 100.

Although the present embodiment describes an example of communicating through the network device 300, the digital camera 100 and the control apparatus 200 may be connected directly.

As illustrated in FIG. 3, in a state where the plurality of digital cameras 100 and the control apparatus 200 that are installed can communicate with each other, the control apparatus 200 can issue shooting commands and accompanying focus driving commands to the individual digital cameras 100. In other words, shooting instructions can be made remotely. Furthermore, the control apparatus 200 can issue commands for obtaining setting information of the digital cameras 100, commands for changing settings, commands for requesting a live view image (send requests), and display obtained information in the display unit 206 or the like.

Such a configuration makes it possible to control the shooting and autofocus by the digital camera 100 from the control apparatus 200.

### Placement of Plurality of Cameras in Sports Stadiums and Viewing Live View Images

A case where live view images from a plurality of digital cameras 100 installed in a sports stadium are viewed as a list in the control apparatus 200 according to the present embodiment will be described next.

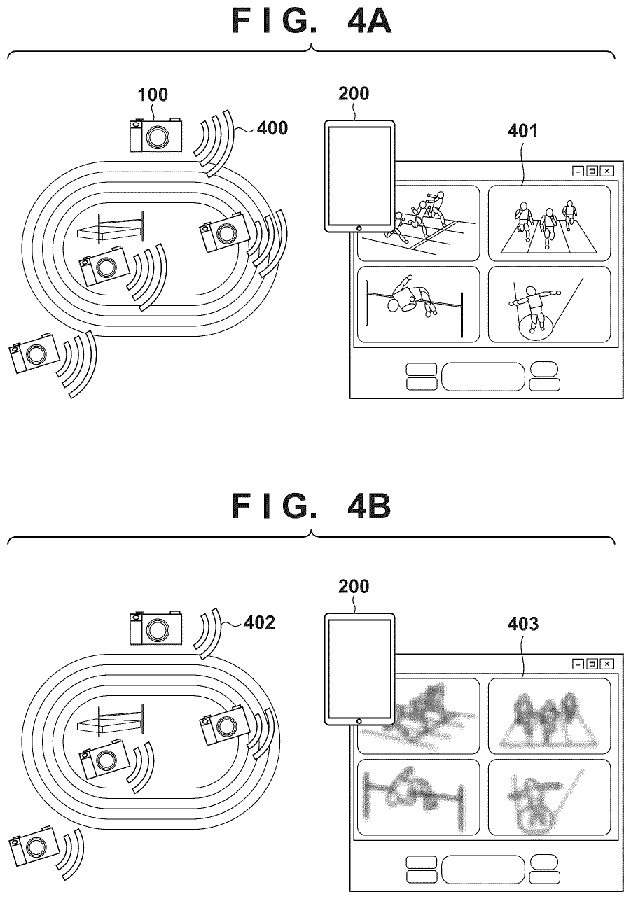

FIGS. 4A and 4B are diagrams schematically illustrating an example in which a plurality of digital cameras 100 installed for different events at a track and field competition venue send live view images to the control apparatus 200, and the control apparatus 200 displays the images side by side.

Live view video data 400 illustrated in FIG. 4A indicates high-quality data having high communication volume, which is displayed by the control apparatus 200 as an image 401 having a higher resolution than a predetermined resolution. On the other hand, live view video data 402 illustrated in FIG. 4B indicates low-quality data having a resolution lower than the predetermined resolution and low communication volume, which is displayed by the control apparatus 200 as an image 403 having a low resolution.

As illustrated in FIG. 4A, sending and displaying the live view images from all the digital cameras 100 to the control apparatus 200 at high image quality and with high communication volume strains the communication bandwidth, increases the processing load on the apps, and the like. On the other hand, displaying all the live view images at a low resolution and a low framerate as illustrated in FIG. 4B worsens the usability by causing delays in responding to changing circumstances, resulting in the risk that critical moments for shooting images will be missed.

There is thus a tradeoff between the image quality of the live view image and the usability for the user, and it is therefore preferable to select the optimal image quality and display the images at that quality in accordance with the shooting situation, the operation status of the control apparatus, and the like.

### Multi-Remote Shooting Control Screen

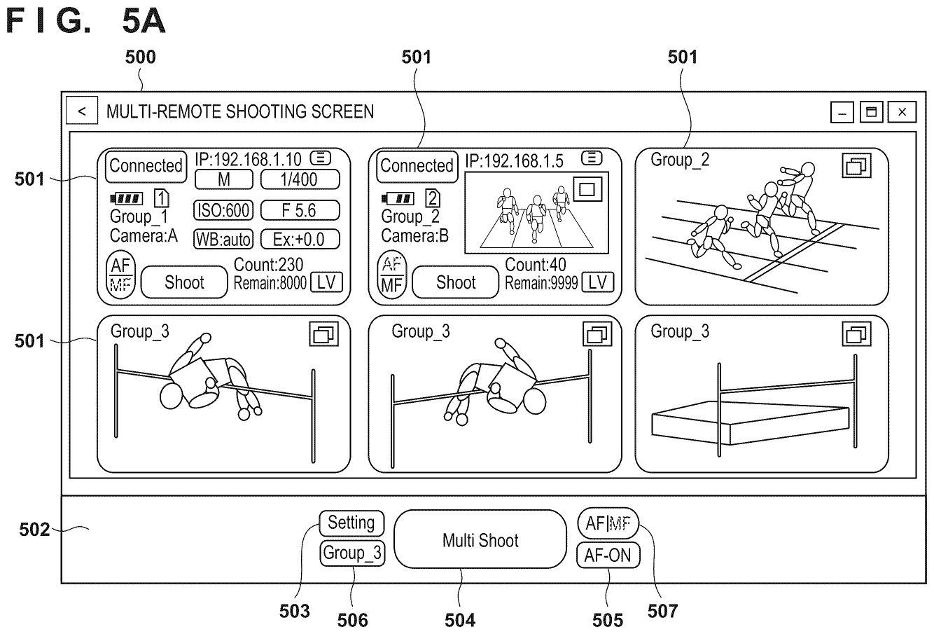

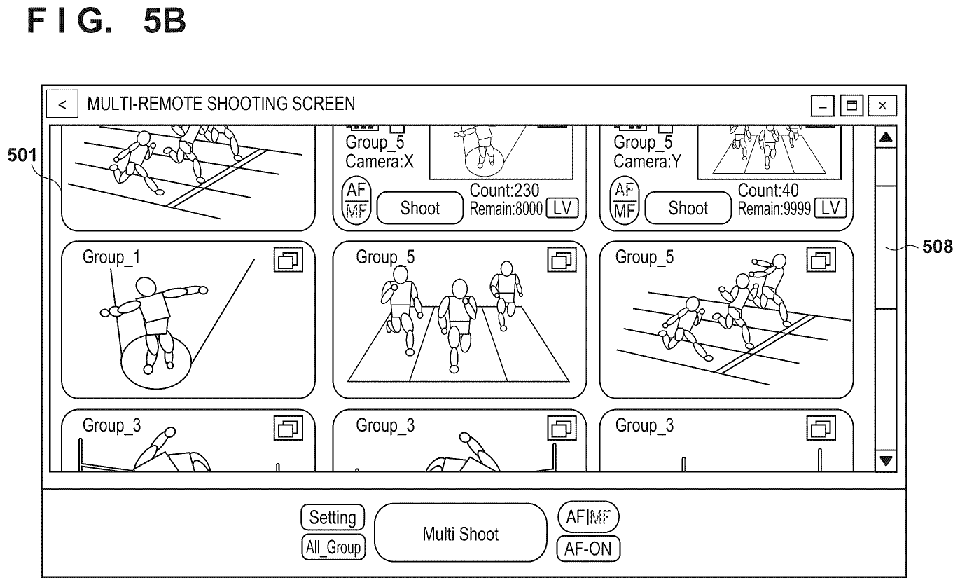

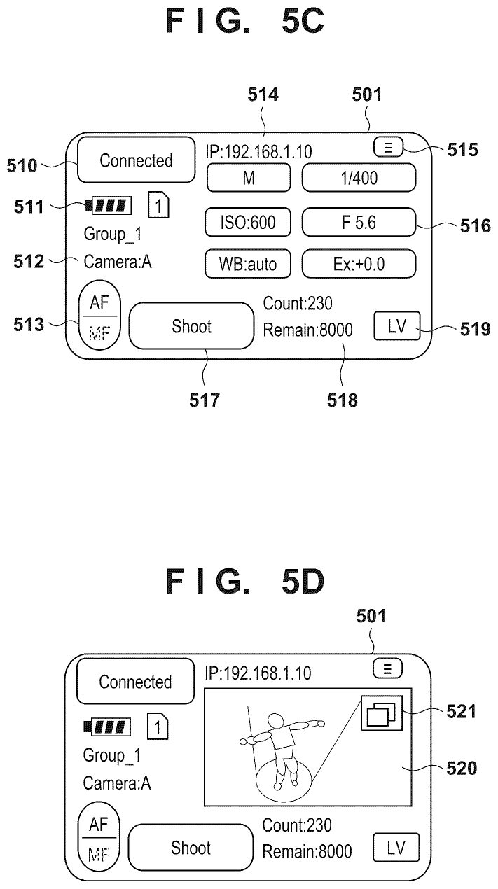

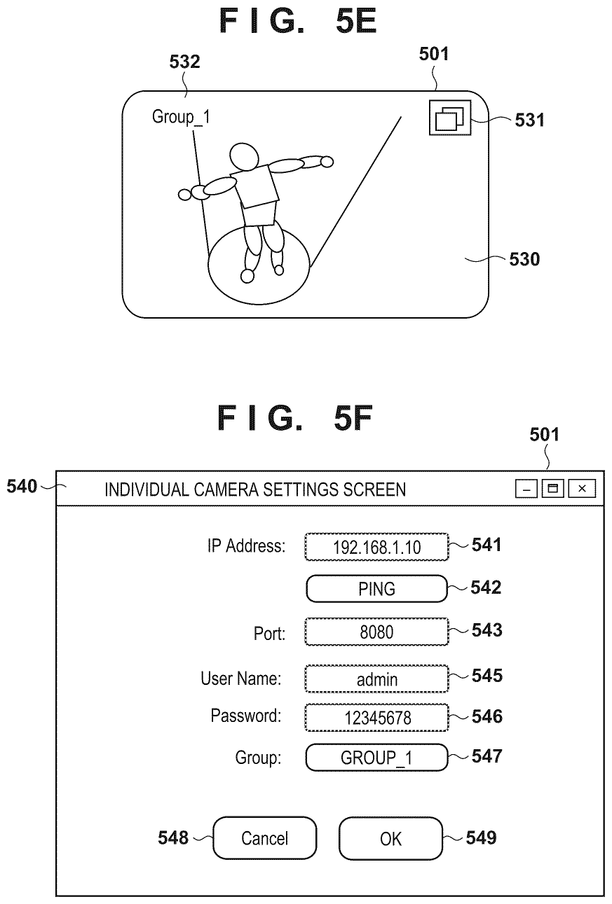

FIGS. 5A to 5F are diagrams illustrating a state in which the plurality of digital cameras 100 are connected to the control apparatus 200 and live view images from the plurality of digital cameras 100 are displayed in each of display regions in the display unit 206 of the control apparatus 200. Using this screen, the control apparatus 200 can control the shooting operations of the plurality of digital cameras 100 (called “multi-remote shooting” hereinafter).

A multi-remote shooting screen 500 illustrated in FIG. 5A includes an individual camera control section 501 for making shooting-related settings, issuing focus commands and shooting commands, and the like for the individual digital cameras 100. The screen also includes a multi-camera control section 502 for making settings, issuing commands, and the like to the plurality of digital cameras 100 at once (control for issuing instructions to the plurality of cameras at once will be called “multi-camera control” hereinafter). Although FIG. 5A illustrates an example in which the plurality of camera screens are displayed in three columns, the configuration is not limited thereto. Fewer than three columns can be displayed, or more columns can be displayed. In this case, the size of the display region is changed according to the number of columns.

As illustrated in FIGS. 5B, 5C, and 5D, the individual camera control section 501 can be used to switch to a different display format according to operations made depending on operations made by the user (i.e., the display method can be changed). The individual camera control section 501 are then displayed side by side in the multi-remote shooting screen 500 in correspondence with the plurality of connected digital cameras 100.

The multi-camera control section 502 can issue commands to the plurality of digital cameras 100 at once. Specifically, the multi-camera control section 502 includes an operation member 503 that instructs settings for shooting parameters at once, an operation member 504 that instructs shooting commands at once, and an operation member 505 that instructs autofocus commands at once. The section also includes an operation member 506 that selects a group of digital cameras to which the instructions from the operation members 503, 504, and 505 are to be sent. The section also includes a display operation member 507 that displays the state of a setting for autofocus and manual focus as a shooting command, and switches between autofocus and manual focus.

Furthermore, FIG. 5B illustrates a screen displayed when there are too many connected digital cameras to be displayed in the multi-remote shooting screen at once, and a screen scrolling member 508 can be used to scroll through the screen to confirm individual cameras not currently displayed in the screen. As can be seen from FIG. 5B, the multi-camera control section 502 stays displayed in the same position even when the screen is scrolled.

### Configuration of Individual Camera Control Section

FIGS. 5C, 5D, and 5E illustrate an example of the configuration of the individual camera control sections 501.

The individual camera control section 501 illustrated in FIG. 5C includes an operation member 510 for controlling the connection state with the digital camera 100, a display member 511 for displaying the power state of the digital camera 100, the status of a recording member, and the like, and a name display member 512 for identifying the individual camera, shooting group, or the like. The display member 511 displays the remaining battery power as an icon representing a battery. The information on the status of the recording member also indicates, in the case of a digital camera 100 into which a plurality of recording media can be inserted simultaneously, into which of the recording media images shot by the digital camera 100 are recorded. Also included are a display operation member 513 for switching between (i) displaying the state of auto and manual focus and (ii) focus settings, a display member 514 for indicating the network address of the digital camera 100, and a setting member 515 for performing various settings for individual camera control. Also included are a member group 516 for changing the shooting settings of the digital camera 100, and an operation member 517 for performing remote shooting control (called “remote shooting” hereinafter) for the individual digital camera 100. Further included are a display member 518 that indicates a remaining number of shots that can be taken and a number of shots already taken by the digital camera 100, and an operation member 519 for controlling the live view display in the digital camera 100.

The user can switch the display format of the individual camera control section 501 using the operation member 519 for controlling the live view display, illustrated in FIG. 5C.

In FIG. 5D, a live view image display part 520 is provided in place of the member group 516 for changing the shooting settings. A live view size switching member 521 is provided within the live view image display part 520, which enables the display size to be switched as illustrated in FIG. 5E.

In FIG. 5E, a live view image display part 530 is provided in the entire region of the individual camera control section 501. Alive view size switching member 531 and a name display member 532 for identifying the shooting group are provided within the live view image display part 530. The live view size switching member 531 enables the display size to be switched as illustrated in FIG. 5D.

Note that the display mode of the live view image display part during the remote shooting described in the present embodiment is merely an example, and the mode may be any mode in which the live view image display is provided to the user.

### Individual Camera Registration Settings Screen

FIG. 5F illustrates an individual camera registration settings screen 540, in which registration settings are made for individual cameras, starting when a connection is established with the digital camera 100.

The individual camera registration settings screen 540 includes an operation member 541 for setting the IP address of the digital camera 100, and an operation member 542 for issuing a ping command from the control apparatus 200 to confirm whether the digital camera 100 is present on the network. Also included are an operation member 543 for setting a port number of the digital camera 100, and a user name setting operation member 545 and password setting operation member 546 for logging into the digital camera 100. Further included are an operation member 547 for setting which group the digital camera 100 belongs to, an operation member 548 for canceling the setting, and an operation member 549 for finalizing the setting.

### Flowcharts of Multi-Live View Image Display Processing by Control Apparatus 200

FIGS. 6A, 6B-1 and 6B-2 are flowcharts illustrating operations performed by the control apparatus 200 when controlling multi-remote shooting performed by the plurality of digital cameras 100. Here, the control apparatus 200 displays a live view image for each individual digital camera 100 in the multi-remote shooting screen. Note that the operations illustrated in these flowcharts are implemented by the control unit 201 of the control apparatus 200 loading a control program stored in the non-volatile memory 203 into the working memory 204 and executing the program.

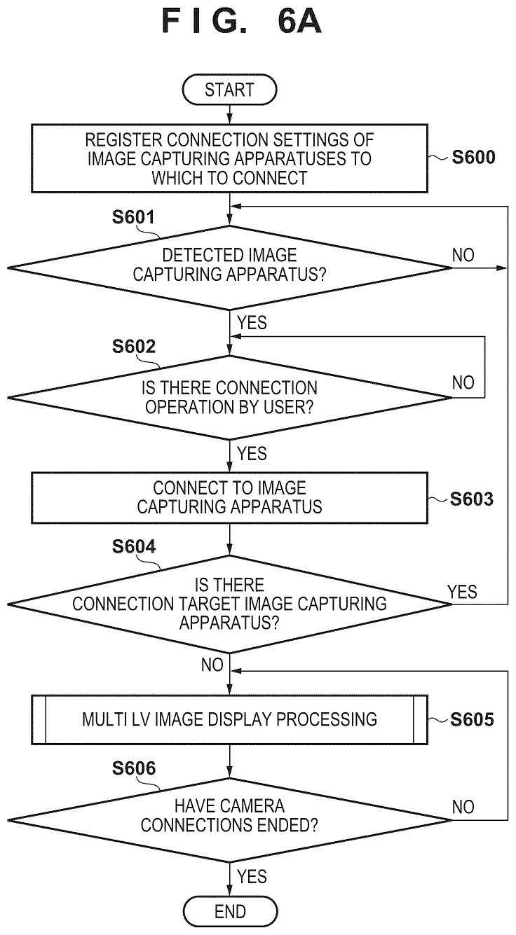

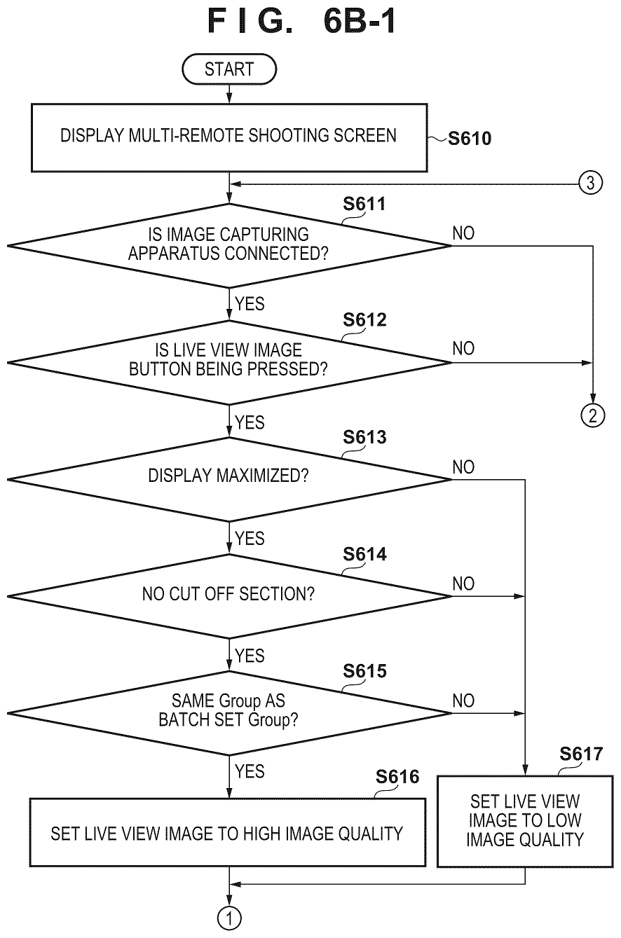

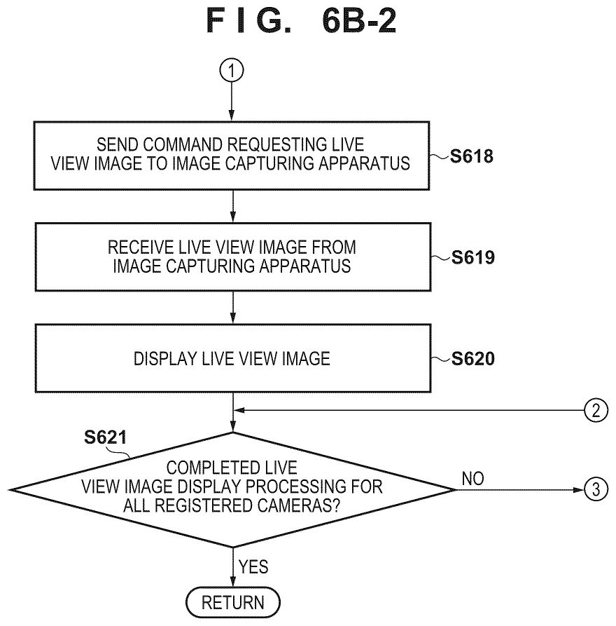

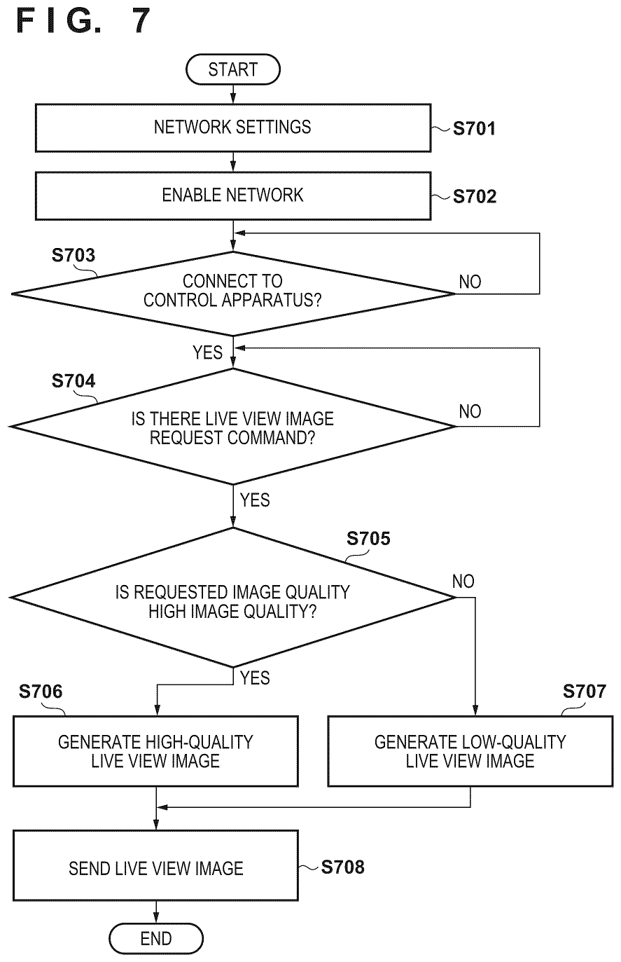

FIG. 6A is a flowchart illustrating operations performed when the control apparatus 200 is connected to the plurality of digital cameras 100, displays the live view images from the plurality of cameras in the multi-remote shooting screen, and then ends the display.

When the control apparatus 200 is started up, in step S600, the control unit 201 registers connection settings of the plurality of digital cameras 100 with which connections are to be established.

In step S601, the control unit 201 performs processing for detecting the digital cameras 100, and determines whether a digital camera 100 has been detected. The control unit 201 moves the sequence to step S602 if the digital camera 100 has been detected, and repeats step S601 if not.

In step S602, the control unit 201 determines whether an operation for connecting the digital camera 100 has been performed by a user. The control unit 201 moves the sequence to step S603 if a connection operation has been made, and repeats step S602 if not.

In step S603, the control unit 201 performs connection processing with the detected digital camera 100 to establish a connection with the digital camera 100.

In step S604, the control unit 201 determines whether there is a second or subsequent digital camera 100 to be connected, for which a connection was registered in step S600. The control unit 201 moves the sequence to step S605 if there is no digital camera 100 to be connected and multi-remote shooting can be started, and returns the sequence to step S601 if a digital camera 100 to be connected remains.

In step S605, the control unit 201 performs multi-live view image display processing, illustrated in FIG. 6A.

In step S606, the control unit 201 determines whether the connections with the plurality of digital cameras 100 have ended. If the connections have not ended, the control unit 201 determines that the user has not ended the multi-remote shooting, and returns the sequence to step S605. If the connections have ended, the operations of this flowchart end.

FIG. 6-1 and FIG. 6B-2 are flowcharts illustrating multi-live view image display processing operations performed by the control apparatus 200 for the plurality of digital cameras 100. These operations are started when a connection between the control apparatus 200 and the plurality of digital cameras 100 is established in step S604 of FIG. 6A.

In step S610, the control unit 201 displays the multi-remote shooting screen illustrated in FIG. 5A.

In step S611, the control unit 201 determines whether a digital camera 100 for which registration settings have been made is in a connected state. If a digital camera 100 is in the connected state, the control unit 201 moves the sequence to step S612; if not, however, there is no need to display a live view image in the multi-remote shooting screen, and thus the control unit 201 moves the sequence to step S621.

In step S612, the control unit 201 confirms whether the operation member 519 for controlling the live view display, illustrated in FIG. 5C, is being pressed. The control unit 201 moves the sequence to step S613 if the member is being pressed, and moves the sequence to step S621 if not. Although whether the operation member 519 has been pressed (manipulated) is confirmed here, it should be noted that the configuration is not limited thereto. For example, whether the current display mode is a state in which the member group 516 is displayed, as illustrated in FIG. 5C, may be determined. In this case, the sequence moves to step S617 if the member group 516 is in a displayed state, and to step S614 if not. In other words, any configuration is sufficient here as long as whether the display has transitioned to a state in which the live view image display part 520 is displayed, as illustrated in FIG. 5D, can be ascertained.

In step S613, the control unit 201 determines whether the live view image display part is being displayed in a maximized form, as indicated by 530 in FIG. 5E. If the live view image display part is maximized, the control unit 201 moves the sequence to step S614; however, if the live view image display part is not maximized, as indicated by 520 in FIG. 5D, the control unit 201 moves the sequence to step S617.

In step S614, the control unit 201 determines whether all the individual camera control sections 501 are displayed in the multi-remote shooting screen 500 without any of those sections being cut off. The control unit 201 moves the sequence to step S615 if none of the sections are cut off, and moves the sequence to step S617 if a section is cut off.

A section being “cut off” refers to a situation where, for example, a part of the individual camera control section 501 does not fit in the multi-remote shooting screen 500 and is not displayed, such as in the upper and lower rows in FIG. 5B. A section not being “cut off” refers to a situation where, for example, the entirety of the individual camera control section 501 is displayed, such as FIG. 5A or the middle row of FIG. 5B. When, for example, the display mode of the individual camera control section 501 is as illustrated in FIG. 5D, the entire live view image display part 520 is displayed so as to be completely visible even if a part of the upper end of an individual camera control section 501 is not displayed. In this case, the section may be determined not to be cut off. Here, for example, when at least a predetermined percentage of the display region of the individual camera control section 501 is hidden, that section may be determined to be cut off. Alternatively, it is conceivable that the content being shot can be ascertained even if the live view image is somewhat obscured, and the section may therefore be determined not to be cut off even if the live view image display part 520 is somewhat obscured. In this case, when at least a predetermined percentage of the live view image display part 520 is hidden, the section may be determined to be cut off.

In step S615, the control unit 201 determines whether the group set by the operation member 506 for selecting the group, illustrated in FIG. 5A, matches the group name of the display member 512 or 532 illustrated in FIGS. 5C, 5D, and 5E. The control unit 201 moves the sequence to step S616 if the groups are the same, and moves the sequence to step S617 if the groups are different.

In step S616, the control unit 201 sets the image quality of the live view image requested by the digital camera 100 to a high image quality, which is higher than a predetermined resolution.

In step S617, the control unit 201 sets the image quality of the live view image requested by the digital camera 100 to a low image quality, which is less than or equal to the predetermined resolution.

In step S618, the control unit 201 sends a command requesting a live view image at the image quality set in steps S616 and S617 to the digital camera 100.

In step S619, the control unit 201 receives the live view image from the digital camera 100.

In step S620, the control unit 201 displays the live view image received from the digital camera 100 in the live view image display part 520 or 530 of the individual camera control section 501.

In step S621, the control unit 201 determines whether the live view image display processing is complete for all the digital cameras 100 displayed in the multi-remote shooting screen 500. If the processing is complete, the control unit 201 moves the sequence to step S606 of FIG. 6A, and if not, the control unit 201 returns the sequence to step S611 and repeats the processing for the other live view image display parts.

### Flowchart of Processing for Sending Live View Image by Digital Camera 100

FIG. 7 is a flowchart illustrating operations performed by the digital camera 100 from receiving a command from the connected control apparatus 200 to sending the live view image. Note that the operations illustrated in this flowchart are implemented by the control unit 101 of the digital camera 100 loading a control program stored in the non-volatile memory 103 into the working memory 104 and executing the program.

The sequence in FIG. 7 is started when the digital camera 100 is arranged at a shooting position and the user turns the digital camera 100 on.

First, in step S701, the control unit 101 makes network settings for connecting to the control apparatus 200.

In step S702, the control unit 101 applies the network settings and stands by for a connection to the control apparatus 200.

In step S703, the control unit 101 determines whether a connection request has been made from the control apparatus 200. The control unit 101 moves the sequence to step S704 if a connection request has been made, and repeats step S703 if not.

In step S704, the control unit 101 determines whether a live view image request command has been made from the control apparatus 200. The control unit 101 moves the sequence to step S705 if a live view image request command has been made, and repeats step S704 if not. In step S705, the control unit 101 determines whether the requested image quality of the live view image is high image quality in the live view image request command received from the control apparatus 200. The control unit 101 moves the sequence to step S706 if the requested image quality is high image quality, and to step S707 if the requested image quality is low image quality.

In step S706, the control unit 101 performs processing for generating a high-quality live view image.

In step S707, the control unit 101 performs processing for generating a low-quality live view image.

In step S708, the control unit 101 sends the live view image to the control apparatus 200, and ends the operations of this flowchart.

As described above, according to the foregoing embodiment, in an individual live view image display in a multi-remote shooting screen, an appropriate image quality can be selected for a live view image (e.g., two types of image quality) in accordance with the size or cut-off parts of a live view image display part, whether group settings are applied, and the like. Furthermore, as described above, even if the live view image display part is partially cut off, the live view display does not stop. Accordingly, the movement of a subject can be ascertained to a certain extent even if the image quality drops slightly, which makes it less likely that a photographer will miss an opportunity to take a shot.

### Second Embodiment

The first embodiment described a situation in which in an individual live view image display in a multi-remote shooting screen, an appropriate image quality for the live view image is selected in accordance with the size or cut-off parts of a live view image display part, whether group settings are applied, and the like.

A second embodiment will describe a method for selecting an appropriate image quality for an individual live view image in a multi-remote shooting screen based on an automatic subject detection function (subject detection results) of the individual digital cameras 100 connected to the control apparatus 200.

### Determining Image Quality of Live View Image Through Subject Detection

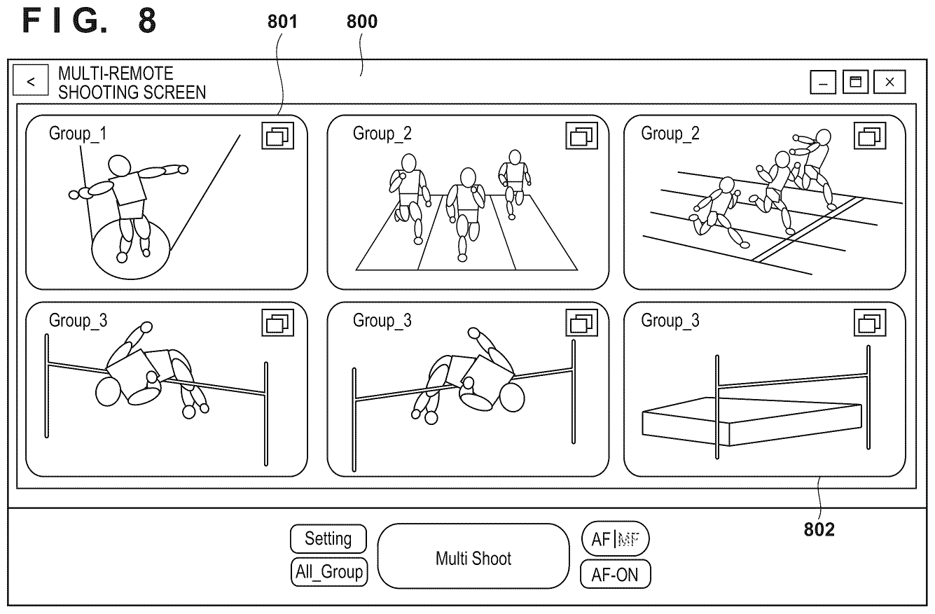

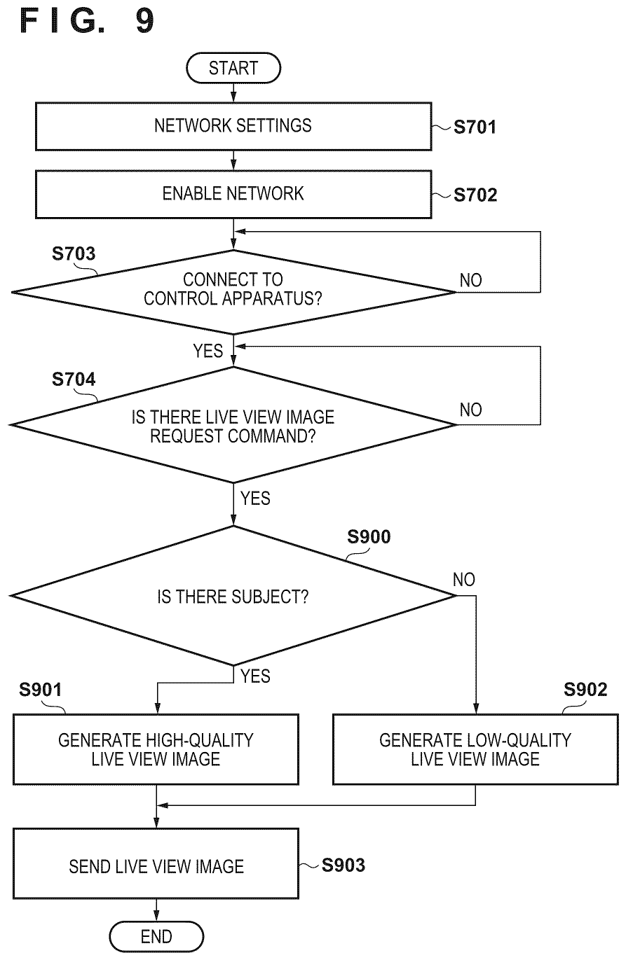

FIG. 8 is a diagram illustrating a state in which the plurality of digital cameras 100 are connected to the control apparatus 200, and live view images from the plurality of digital cameras 100 are displayed side by side in a multi-remote shooting screen (the display unit 206) of the control apparatus 200.

As illustrated in FIG. 8, in a track and field competition, when there is an event 802 in which no competition is being held, no subject appears in the live view image, and the user is therefore unlikely to perform a shooting operation. However, if the live view image display is switched off, there is a risk that the user will be unable to respond to changes in the situation when the competition is started and will miss a chance to take a shot.

Accordingly, in the present embodiment, whether a subject to be shot is present in the live view image is determined, and the image quality of the live view image displayed in the multi-remote shooting screen is set.

FIG. 9 is a flowchart illustrating operations performed by the digital camera 100 from receiving a command from the connected control apparatus 200 and determining whether a subject is present, to sending the live view image. Because the flowchart in FIG. 9 has many parts that are the same as the flowchart in FIG. 7, identical parts will be given the same step numbers and will not be described.

When, in step S704 of FIG. 7, a live view image request command has been made from the control apparatus 200, the control unit 101 of the digital cameras 100 moves the sequence to step S900.

In step S900, the control unit 101 determines whether a subject set in advance, such as a person, an animal, a car, or the like, has been detected within a range being shot by the digital camera 100 using the image sensor. The control unit 101 moves the sequence to step S901 if a subject has been detected, and to step S902 if not.

In step S901, the control unit 101 performs processing for generating a high-quality live view image having a resolution higher than a predetermined resolution.

In step S902, the control unit 101 performs processing for generating a low-quality live view image having a resolution less than or equal to the predetermined resolution, and moves the sequence to step S903.

In step S903, the control unit 101 sends the live view image to the control apparatus 200, and ends the operations of this flowchart.

Although the present embodiment has described an example in which a function of the digital camera 100 is used to detect the subject, the configuration is not limited thereto. For example, AI processing technology or the like in the control apparatus 200 may be used to detect a specific subject.

### Third Embodiment

### Determining Image Quality of Live View Image Through Remote Shooting Operation with Plurality of Control Apparatuses Connected

The first and second embodiments described examples of optimizing individual live view image displays in the multi-remote shooting screen of the control apparatus 200, and optimizing the live view image display using a detection function of the digital camera 100, respectively.

A third embodiment will describe a method for displaying a live view image having an optimal image quality for each individual camera in a multi-remote shooting screen, in a multi-remote shooting system in which a plurality of control apparatuses 200 are connected.

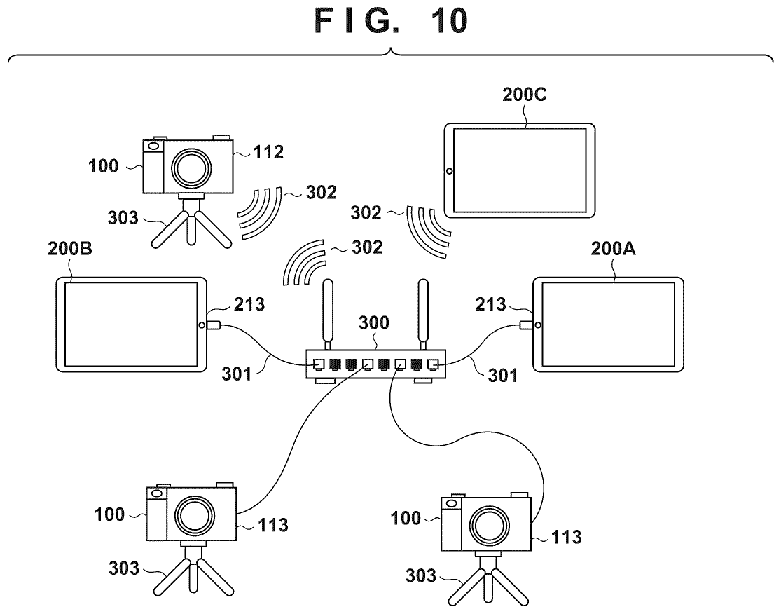

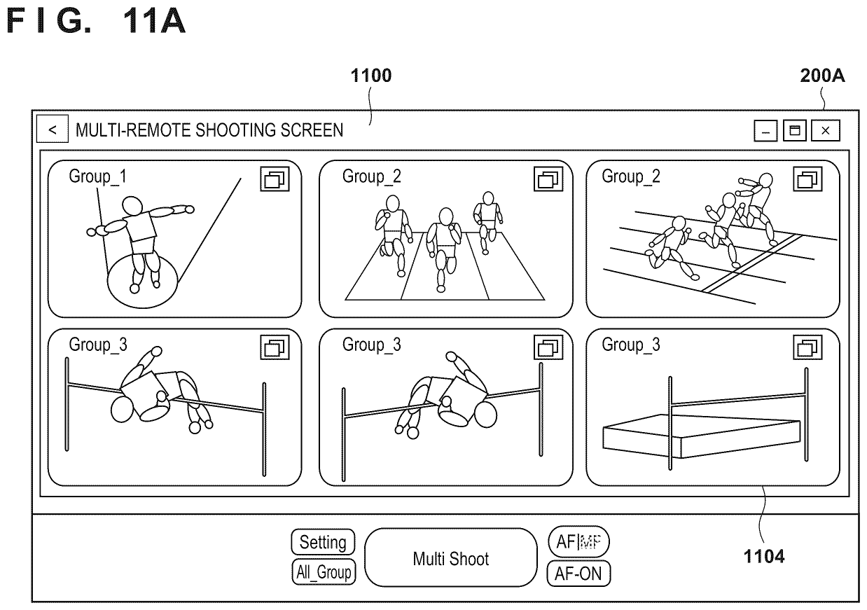

FIG. 10 is a diagram illustrating the configuration of a system in which a plurality of the control apparatuses 200 and a plurality of the digital cameras 100 are connected through the network device 300, and control apparatuses control the digital cameras remotely.

A case such as the following is conceivable as a usage situation in which a plurality of users perform multi-remote shooting using corresponding control apparatuses. That is, for example, one control apparatus is used when a photographer who is continually shooting images is shooting images in the vicinity of a competition, while another control apparatus is used to confirm shot images, transfer data, perform shooting assistance tasks, and the like somewhere in the competition venue, such as a main press center. In such a usage situation, the live view image of the digital camera being operated from one control apparatus may be an image to which the user operating the other control apparatus should also pay attention.

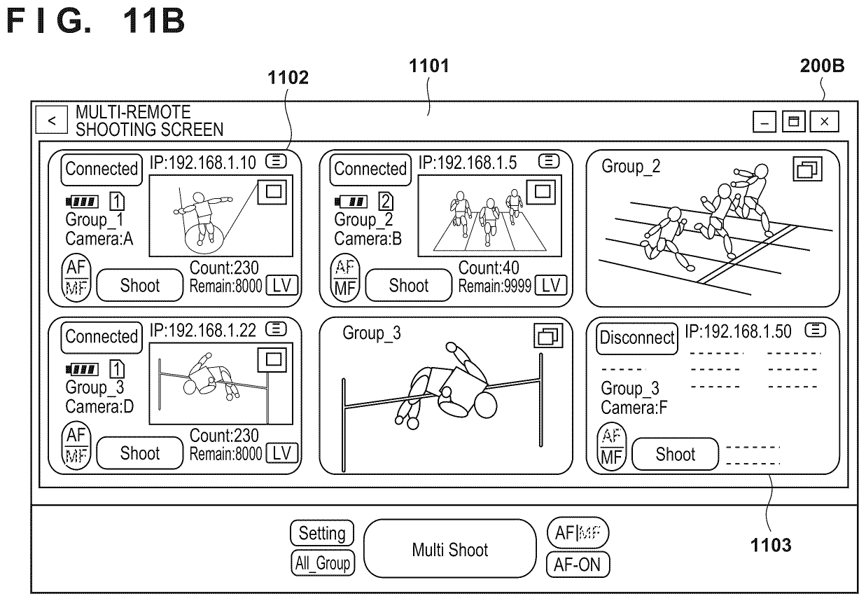

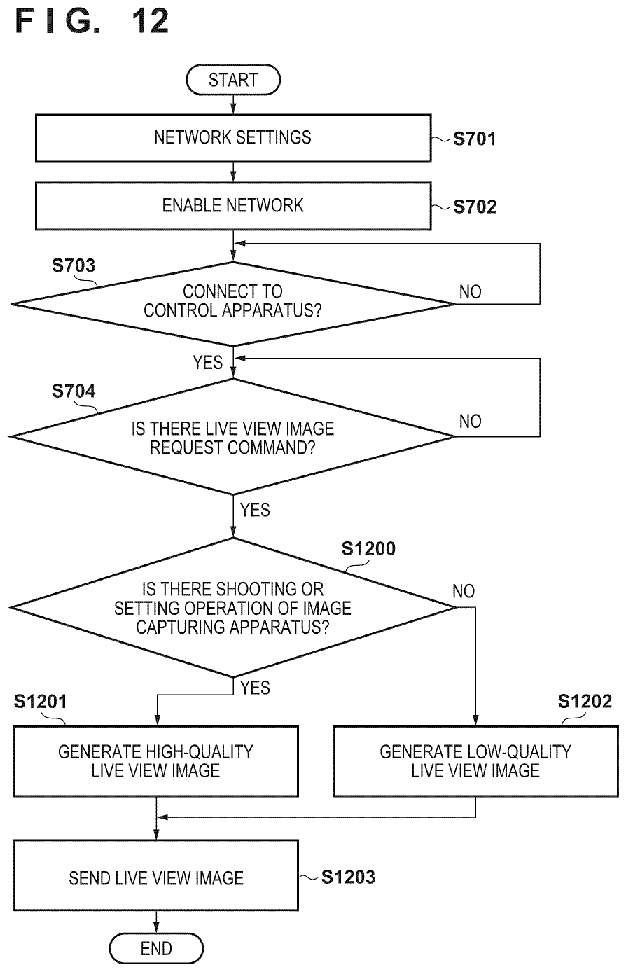

FIGS. 11A and 11B are diagrams illustrating a state in which multi-remote shooting is performed using separate control apparatuses at the same time, and during the same track and field competition. FIG. 11A illustrates a multi-remote shooting screen 1100 of a control apparatus 200A, and FIG. 11B illustrates a multi-remote shooting screen 1101 of a control apparatus 200B.

The live view images from all the digital cameras are displayed in the multi-remote shooting screen 1100 of the control apparatus 200A. An individual camera control section 1102, in which individual shooting operations can be performed, and an individual camera control section 1103, in which the individual camera is indicated as being disconnected and shooting operations therefore cannot be performed, are displayed in the multi-remote shooting screen 1101 of the control apparatus 200B.

At this time, a live view image is displayed in an individual camera control section 1104 of the multi-remote shooting screen 1100 of the control apparatus 200A, but that camera is a digital camera which is not connected to and is not being operated by the control apparatus 200B. It is therefore sufficient to display a low-quality live view image in the multi-remote shooting screen of the control apparatus 200A, as long as it is not necessary for the user operating the control apparatus 200A to pay attention to that image.

On the other hand, for a digital camera connected to and being operated by the other control apparatus 200B, it is preferable to display a high-quality live view image as long as the image should also be paid attention to in the control apparatus 200A.

Accordingly, in the present embodiment, it is determined whether a shooting or setting operation has been issued to the digital camera from any of the connected control apparatuses, and the image quality of the live view image displayed in the multi-remote shooting screen is set accordingly.

FIG. 12 is a flowchart illustrating operations performed by the digital camera 100 from receiving a command from the connected control apparatus 200 and determining whether a shooting operation or a setting operation has been performed in the camera, to sending the live view image. Because the flowchart in FIG. 12 has many parts that are the same as the flowchart in FIG. 7, identical parts will be given the same step numbers and will not be described.

When, in step S704 of FIG. 7, a live view image request command has been made from the control apparatus 200, the control unit 101 of the digital cameras 100 moves the sequence to step S1200.

In step S1200, the control unit 101 determines whether an operation taking a set amount of time, such as a shooting operation, a setting operation, or the like, has been performed by the digital camera 100. The control unit 101 moves the sequence to step S1201 if such an operation has been made, and to step S1202 if not.

In step S1201, the control unit 101 performs processing for generating a high-quality live view image having a resolution higher than a predetermined resolution.

In step S1202, the control unit 101 performs processing for generating a low-quality live view image having a resolution less than or equal to the predetermined resolution.

In step S1203, the control unit 101 sends the live view image to the control apparatus 200, and ends the operations of this flowchart.

The present embodiment describes an example in which, when a shooting or setting operation is being performed for the camera from one control apparatus, it is determined that the other control apparatus should also pay attention to that camera, and the live view image is displayed at a high image quality. However, the present invention is not limited thereto. For example, when a plurality of users perform remote shooting operations, the image quality of the live view image of a camera not being operated may be set to high image quality in order to compensate for shooting operations of a camera not being paid attention to by one of the users.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-144704, filed Sep. 6, 2023, which is hereby incorporated by reference herein in its entirety.

What is claimed is:

1. A control system in which a plurality of image capturing apparatuses are controlled by a control apparatus,
wherein the control apparatus includes:
at least one processor or circuit configured to function as:
a display control unit configured to be capable of controlling display device to display a live view image sent from each of the plurality of image capturing apparatuses in a plurality of display regions, each corresponding to one of the plurality of image capturing apparatuses, in the display device, and capable of changing a display method for each of the plurality of display regions; and
a first communication unit configured to request the live view image from each of the image capturing apparatuses, and
each of the image capturing apparatuses includes:
an image capturing device configured to generate the live view image at a different image quality according to a send request for the live view image from the control apparatus; and
at least one processor or circuit configured to function as
a second communication unit configured to send the live view image generated by the image capturing device to the control apparatus.

2. The control system according to claim 1,
wherein the first communication unit makes a request to each of the image capturing apparatuses for the live view image at the image quality suited to the image capturing apparatus in accordance with the display method for each of the plurality of display regions, and
the image capturing device generates the live view image at the image quality requested by the control apparatus.

3. The control system according to claim 2,
wherein the first communication unit makes a request to the image capturing apparatus to send a low-quality live view image having a resolution less than or equal to a predetermined resolution when the display control unit is not displaying the live view image in a maximized state.

4. The control system according to claim 2,
wherein the first communication unit makes a request to the image capturing apparatus to send a low-quality live view image having a resolution less than or equal to a predetermined resolution when the live view image displayed in the display region is cut off.

5. The control system according to claim 1,
wherein each of the image capturing apparatuses further includes subject detection unit for detecting a subject, and
the image capturing device changes the image quality of the live view image generated, in accordance with a detection result from the subject detection unit.

6. The control system according to claim 5,
wherein the image capturing device generates a high-quality live view image having a resolution higher than a predetermined resolution when a subject is detected by the subject detection unit.

7. The control system according to claim 5,
wherein the subject detected by the subject detection unit includes a person, an animal, or a car.

8. The control system according to claim 1,
wherein the image capturing device generates a high-quality live view image having a resolution higher than a predetermined resolution when a command for a shooting operation or a setting operation is sent to the image capturing apparatus from the control apparatus.

9. The control system according to claim 1,
wherein the image capturing device generates live view images having two types of image qualities.

10. The control system according to claim 9,
wherein the image capturing device generates a high-quality live view image having a resolution higher than a predetermined resolution, and a low-quality live view image having a resolution less than or equal to the predetermined resolution.

11. The control system according to claim 1,
wherein the display control unit can change a size of the live view image for each of the plurality of display regions.

12. The control system according to claim 1,
wherein the display control unit controls the display device to display, in the display region, a live view image sent from the image capturing apparatus corresponding to the display region and an operation part for operating the image capturing apparatus.

13. The control system according to claim 1,
wherein the display control unit is capable of performing control to skip displaying, in the display region, the live view image sent from the image capturing apparatus corresponding to the display region.

14. The control system according to claim 1,
wherein the display device is built into the control apparatus.

15. An image capturing apparatus controlled by a control apparatus, the image capturing apparatus comprising:
an image capturing device configured to generate a live view image at a different image quality according to a send request for the live view image from the control apparatus; and
at least one processor or circuit configured to function as
a communication unit configured to send the live view image generated by the image capturing device to the control apparatus.

16. A method for controlling an image capturing apparatus controlled by a control apparatus, the method comprising:
performing image capturing that generates a live view image at a different image quality according to a send request for the live view image from the control apparatus; and
sending the live view image generated in the image capturing to the control apparatus.

17. A non-transitory computer-readable storage medium storing a program for causing a computer to execute each of steps of a method for controlling an image capturing apparatus controlled by a control apparatus, the method comprising:
performing image capturing that generates a live view image at a different image quality according to a send request for the live view image from the control apparatus; and
sending the live view image generated in the image capturing to the control apparatus.
